(19) United States
(12) Patent Application Publication
(10) Pub. No.: US 2010/0248880 A1
(43) Pub. Date: Sep. 30, 2010

(54) CYLINDRICAL ROLLER-INCORPORATED ROLLER CHAIN

(76) Inventors: Makoto Fujiwara, Osaka (JP); Ryutaro Nakamura, Osaka (JP)

Correspondence Address: DANN, DORFMAN, HERRELL & SKILLMAN, 1601 MARKET STREET, SUITE 2400, PHILADELPHIA, PA, 19103-2307, US

(21) Appl. No.: 12/789,490

(22) Filed: May 28, 2010

Related U.S. Application Data
(63) Continuation of application No. 12/015,682, filed on Jan. 17, 2008.

(30) Foreign Application Priority Data
Mar. 20, 2007 (JP) 2007-072421

(51) Int. Cl. F16G 13/02

(52) U.S. Cl. 474/209

(57) ABSTRACT

A cylindrical roller-incorporated roller chain, which can reduce wear of the side plates and also can reduce radial wear. A roller chain for a conveyor in which a plurality of cylindrical rollers are composed of either a casehardened steel cylindrical roller 4 or an oil-impregnated sintered alloy cylindrical roller 5. The casehardened steel cylindrical rollers 4 and the oil-impregnated sintered alloy cylindrical rollers 5 are alternately disposed in a circumferential direction. A pair of side plates 6, 6 are each composed of an oil-impregnated sintered alloy having a collar portion 6a and a cylindrical portion 6b. One axial end surface of each collar portion 6a abuts on an end surface of the hollow roller 3 (having no collar), and each cylindrical portion 6b is fitted between the inner circumferential surface of the roller 3 and the outer circumferential surface of the bushing 2. The fit between an outer circumferential surface of the cylindrical portion 6b and the inner circumferential surface of the hollow roller 3 is a close fit and the fit between the inner circumferential surface of the each cylindrical portion 6b and the outer circumferential surface of the bushing is a loose fit.

### CROSS REFERENCE TO RELATED APPLICATION

This application is a continuation application of U.S. patent application Ser. No. 12/015,682, filed Jan. 17, 2008, which in turn claims priority to JP Application No. 2007-072421, filed Mar. 20, 2007, the foregoing applications being incorporated herein by reference.

### FIELD OF INVENTION

The present invention relates to a cylindrical roller-incorporated roller chain comprising a bushing whose both end portions are connected to bushing holes in a pair of inner plates, a special roller having no collar on an inner circumferential surface of said roller, said special roller being disposed between said pair of inner plates, a plurality of cylindrical rollers each incorporated between said bushing and said special roller, and a pair of side plates respectively disposed on both end portions of said special roller. The special roller is hollow with a cylindrical bore whose inside diameter extends to the opposite ends of the roller to allow the cylindrical rollers to be slidably inserted into and/or removed from a position between the bushing and the special roller.

### BACKGROUND OF THE INVENTION

As cylindrical roller bearing-incorporated roller chains, the following roller chains have been provided.

That is, a cylindrical roller-incorporated roller chain has been proposed, which comprises a bushing whose both end portions are connected to bushing holes of a pair of inner plates, a roller having no collar on an inner circumferential surface disposed between the pair of inner plates, a plurality of cylindrical rollers incorporated between the bushing and the roller having no collar, and a pair of thrust bearing plates (corresponding to the side plate of the present invention) respectively disposed on both end portions of the roller having no collar, and in which the plurality of cylindrical rollers are each composed of a steel cylindrical roller and a carbon-impregnated ceramic cylindrical roller, the steel cylindrical roller and the carbon-impregnated ceramic cylindrical roller are alternately disposed in a circumferential direction, the pair of thrust bearing plate are each made of steel and formed in a disk plate, and each thrust bearing plate is fit to an outer circumferential surface of the bushing (see for example Japanese Laid-Open Patent Publication 2002-340106).

The cylindrical roller-incorporated roller chain disclosed in the above-mentioned Japanese Laid-Open Patent Publication has the following problems.

When a roller is rotated, since each steel disk-shaped thrust bearing plate is fitted to an outer circumferential surface of a bushing by a close fit, end surfaces of each thrust bearing plate friction-slide with both end surfaces of the roller. This friction slide allows both end surfaces of each thrust bearing plate to wear. Further, this friction slide increases rotational resistance of each thrust bearing plate so that abnormal sound can occur.

Further, a carbon-impregnated ceramic cylindrical roller has a larger radial wear due to a self rotation and a non-self rotation as compared with a steel cylindrical roller, and this wear becomes a cause of skew (the cylindrical roller slants with reference to a proper self rotational axis).

Accordingly, an object of the present invention is to provide a cylindrical roller-incorporated roller chain, which can reduce wear of a side plate and also can reduce radial wear.

### SUMMARY OF THE INVENTION

The invention is a cylindrical roller-incorporated roller chain comprising a bushing whose both end portions are connected to bushing holes in a pair of inner plates, a special roller (having no collar on an inner circumferential surface) is disposed between said pair of inner plates, a plurality of cylindrical rollers each incorporated between said bushing and said special roller, and a pair of side plates respectively disposed on both end portions of said special roller, characterized in that said plurality of cylindrical rollers are composed either of a steel cylindrical roller or an oil-impregnated sintered alloy cylindrical roller, said steel cylindrical rollers and said oil-impregnated sintered alloy cylindrical rollers are alternately disposed in a circumferential direction, and said pair of side plates are each composed of an oil-impregnated sintered alloy having a collar portion and a cylindrical portion. One end surface of said each collar portion abuts on an end surface of said special roller, said each cylindrical portion being fitted between the inner circumferential surface of said roller and the outer circumferential surface of said bushing. The fit between the outer circumferential surface of said cylindrical portion and the inner circumferential surface of said roller is a close fit and the fit between the inner circumferential surface of said each cylindrical portion and the outer circumferential surface of said bushing being a loose fit.

According to the invention, the following effects are obtained.

When a roller is rotated, since the fit between an outer circumferential surface of each cylindrical surface and an inner circumferential surface of the roller is a close fit, each oil-impregnated sintered alloy side plate is rotated together with the roller. Then an outer side surface of each oil-impregnated sintered alloy side plate and an inner side surface of each inner plate slide frictionally. In that case, since each oil-impregnated sintered alloy side plate has a self lubricity, wear between the outer side surface of each oil-impregnated sintered alloy side plate and the inner side surface of each inner plate can be reduced. As the result a rotational resistance of the roller due to frictional sliding between the outer side surface of each oil-impregnated sintered alloy side plate and the inner side surface of each inner plate can be reduced so that abnormal sound due to the rotation of the roller can also be reduced.

Further, an inner end surface of each cylindrical portion restricts the axial movement of the steel cylindrical rollers and the oil-impregnated sintered alloy cylindrical rollers. Therefore, even if the steel cylindrical roller and the oil-impregnated sintered alloy cylindrical roller are moved in the axial direction due to skew so that its end surface is press-fitted to an inner end surface of each cylindrical portion, since each oil-impregnated sintered alloy side plate has self lubricity, the rotational resistance of the roller due to this press-fitting can be also reduced so that abnormal sound due to the rotation of the roller can be also reduced.

Further, since the contact area between the inner side surface of each inner plate and the opposed outer side surface of each oil-impregnated sintered alloy side plate is large, the contact surface pressure is lowered, and the wear on the outer side surface of each oil-impregnated sintered alloy side plate and on the inner side surface of each inner plate can be reduced.

Further, since the plurality of cylindrical rollers incorporated between the bushing and the special roller are alternately composed of a steel cylindrical roller and an oil-impregnated sintered alloy cylindrical roller, the radial wear of the plurality of cylindrical rollers can be reduced. As a result the generation of the skew can be reduced.

### BRIEF DESCRIPTION OF THE DRAWINGS

FIG. 1 is a cross-sectional view of the main portion of a roller chain for a conveyor, which is an example of the present invention;

FIG. 2 is a cross-sectional view taken along the line II-II in FIG. 1; and

FIG. 3 is a fragmentary plan view of a roller chain embodying the present invention.

### PREFERRED EMBODIMENT OF THE INVENTION

The best mode of the cylindrical roller-incorporated roller chain according to the present invention is one adapted to a roller chain for a conveyor. And the best mode is illustrated in the drawings.

The drawings illustrate a cylindrical roller-incorporated roller chain in a conveyor 10 comprising a bushing 2 whose both end portions are connected to bushing holes 1a in a pair of inner plates 1, 1. A special hollow roller 3 (having no collar on an inner circumferential surface) is disposed between the pair of inner plates 1, 1; a plurality of cylindrical rollers are rotatably mounted between the bushing 2 and the special roller 3; and a pair of side plates 6, 6 respectively are disposed on both end portions of the roller 3. The plurality of cylindrical rollers are composed either of steel cylindrical rollers 4 or of oil-impregnated sintered alloy cylindrical rollers 5, the steel cylindrical roller 4 and the oil-impregnated sintered alloy cylindrical roller 5 are alternately disposed in a circumferential direction. The pair of side plates 6, 6 are each composed of an oil-impregnated sintered alloy having a radially-projecting collar portion 6a and an axially-extending cylindrical portion 6b. An axial end surface of the each collar portion 6a abuts an end surface of the special roller 3. Each cylindrical portion 6b is fitted between the inner circumferential surface of the special roller 3 and the outer circumferential surface of the bushing 2. The fit between the outer circumferential surface of the cylindrical portion 6b and the inner circumferential surface of the special roller 3 is a close fit, and the fit between the inner circumferential surface of the cylindrical portion 6b and the outer circumferential surface of the bushing 2 is a loose fit.

The example of the above-mentioned roller chain will be described hereinbelow.

The cylindrical roller-incorporated roller chain 10 for a conveyor according to the present invention will be described below.

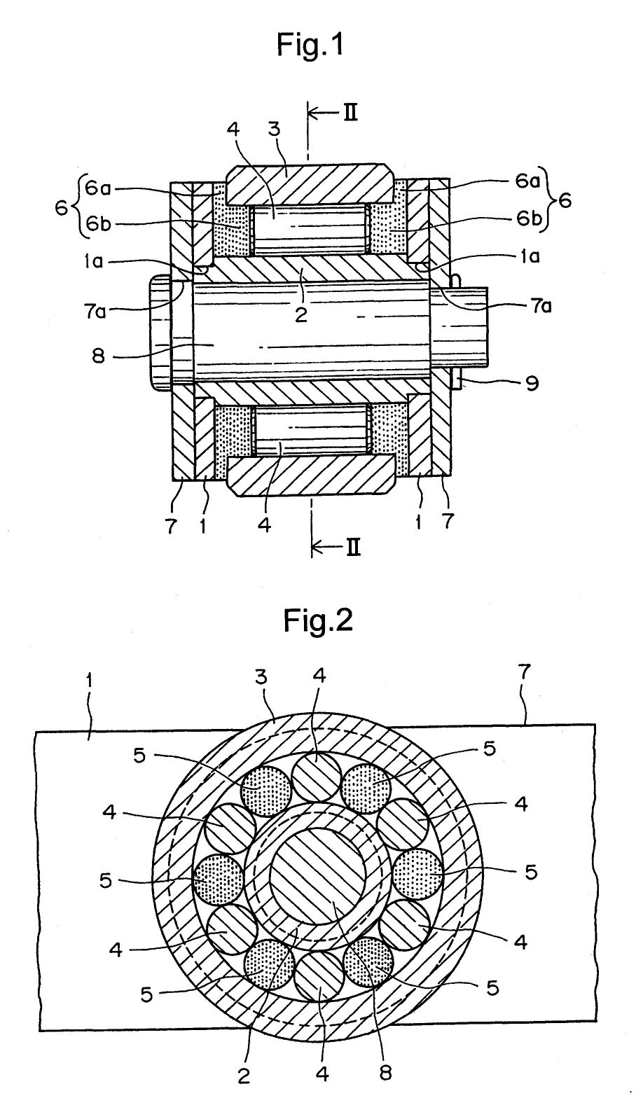

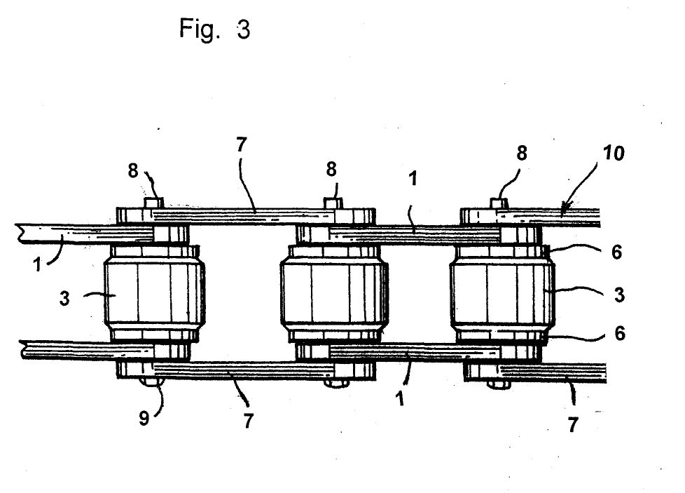

The cylindrical roller-incorporated roller chain for a conveyor of an example according to the present invention comprises, as shown in FIG. 1, a bushing 2 whose both end portions are mounted in bushing holes 1a in a pair of inner plates 1, 1. A special hollow roller 3 (having no collar on an inner circumferential surface) is disposed between the pair of inner plates 1, 1. A series of cylindrical rollers 4 and 5 surrounds the bushing 2 between the bushing 2 and the special roller 3. A pair of inner side plates 6, 6 are respectively disposed on both end portions of the hollow roller 3. A pair of outer plates 7, 7 are disposed outside the pair of inner plates 1, 1. A headed pin 8 passes through the bushing 2, and has both ends connected to pin holes 7a in the pair of outer plates 7, 7. Further, a split pin 9 is attached to the free end portion of the pin 8. It should be noted that the special hollow roller 3 has a straight cylindrical shape having no collar on its inner and outer circumferential surfaces.

In this example, a tough steel is used for the pair of inner plates 1, 1. The bushing 2, a casehardened steel (JIS MARK: SCM 415). The special roller 3 is formed of a casehardened steel (JIS MARK: SCM 425). The pair of outer plates 7, 7, use a tough steel, and the pin 8 uses a casehardened steel (JIS MARK: SCM 415).

As shown in FIG. 2, alternate cylindrical rollers 4 incorporated between the bushing 2 and the special hollow roller are composed of a casehardened steel (JIS MARK: SCM 425) and the intermediate rollers 5 are composed of an oil-impregnated sintered alloy. The casehardened steel cylindrical roller 4 and the oil-impregnated sintered alloy cylindrical roller 5 are alternately disposed in a circumferential direction.

As shown in FIG. 1, the pair of side plates 6, 6 are composed of an oil-impregnated sintered alloy each having a collar portion 6a and a cylindrical portion 6b. The inner axial end surface of each collar portion 6a abuts on an end surface of the hollow roller 3. Each cylindrical portion 6b is fitted between an inner circumferential surface of the hollow roller 3 and the outer circumferential surface of the bushing 2. The fit between the outer circumferential surface of each cylindrical portion 6b and an inner circumferential surface of the hollow roller 3 is a close fit, so that the side plates 6,6 may rotate together with the hollow roller 3, and the fit between the inner circumferential surface of each cylindrical portion 6b and an outer circumferential surface of the bushing 2 is a loose fit, so that the series of cylindrical rollers may revolve around the bushing 2 independently of the hollow roller 3.

Next, the operation and effects of the roller chain for a conveyor of the example according to the present invention will be described.

When the special hollow roller 3 is rotated, since the fit between an outer circumferential surface of each cylindrical surface 6b and an inner circumferential surface of the roller 3 is a close fit, each oil-impregnated sintered alloy side plate 6 is rotated together with the roller 3. As a result, the axial outer side surface of each oil-impregnated sintered alloy side plate 6 and the inner side surface of the inner plate 1 slide frictionally. In that case, since each oil-impregnated sintered alloy side plate 6 has a self lubricity, wear between the outer side surface of each oil-impregnated sintered alloy side plate 6 and the inner side surface of each inner plate 1 can be reduced. As the result a rotational resistance of the roller 3 due to frictional sliding between the outer side surface of each oil-impregnated sintered alloy side plate 6 and the inner side surface of each inner plate 1 can be reduced so that abnormal sound due to the rotation of the special roller 3 can also be reduced.

Further, an inner axial end surface of each cylindrical portion 6b restricts the axial movement of the casehardened steel cylindrical rollers 4 and the oil-impregnated sintered alloy cylindrical rollers 5. Therefore, even if the casehardened steel cylindrical roller 4 and the oil-impregnated sintered alloy cylindrical roller 5 are moved in the axial direction due to skew so that its end surface is press-fitted to an inner axial end surface of each cylindrical portion 6b, since each oil-impregnated sintered alloy side plate 6 has self lubricity, the rotational resistance of the roller 3 due to this press-fitting can be also reduced so that abnormal sound due to the rotation of the roller 3 can be also reduced.

Further, since the contact area between the inner side surface of each inner plate 1 and the opposed outer side surface of each oil-impregnated sintered alloy side plate 6 is large, the contact surface pressure is lowered, and the wear on the outer side surface of each oil-impregnated sintered alloy side plate 6 and on the inner side surface of each inner plate 1 can be reduced.

Further, since in the circumferential series of cylindrical rollers incorporated between the bushing 2 and the roller 3 are alternately composed of a casehardened steel cylindrical roller 4 and an oil-impregnated sintered alloy cylindrical roller 5, the radial wear of the series of cylindrical rollers can be reduced. As a result the generation of the skew can be reduced.

1. A cylindrical roller-incorporated roller chain comprising a bushing whose both end portions are connected to bushing holes in a pair of inner plates, a special hollow roller having no collar on an inner circumferential surface disposed between said pair of inner plates, a series of cylindrical rollers incorporated between said bushing and said special hollow roller, and a pair of side plates respectively disposed on both axial end portions of said special hollow roller, characterized in that
said series of cylindrical rollers are composed either of a steel cylindrical roller or of an oil-impregnated sintered alloy cylindrical roller, said steel cylindrical roller and said oil-impregnated sintered alloy cylindrical roller being alternately disposed in a circumferential direction,
said pair of side plates are each composed of an oil-impregnated sintered alloy having a collar portion and a cylindrical portion, an axial end surface of said each collar portion abutting on an end surface of said special hollow roller, said each cylindrical portion being fitted between the inner circumferential surface of said hollow roller and the outer circumferential surface of said bushing, the fit between the outer circumferential surface of said each cylindrical portion and the inner circumferential surface of said hollow roller being a close fit and the fit between an inner circumferential surface of said each cylindrical portion and an outer circumferential surface of said bushing being a loose fit.
